(19) United States
(12) Patent Application Publication
(10) Pub. No.: US 2021/0014362 A1
(43) Pub. Date: Jan. 14, 2021

(54) INFORMATION PROCESSING APPARATUS, METHOD OF CONTROLLING INFORMATION PROCESSING APPARATUS, AND STORAGE MEDIUM

(71) Applicant: CANON KABUSHIKI KAISHA, Tokyo (JP)

(72) Inventor: Ruriko Kawano, Kawasaki-shi (JP)

(21) Appl. No.: 16/925,424

(22) Filed: Jul. 10, 2020

(30) Foreign Application Priority Data
Jul. 10, 2019 (JP) 2019-128269

(51) Int. Cl. H04N 1/00; G06F 16/587; G06F 16/58

(52) U.S. Cl. CPC H04N 1/00153; G06F 16/5866; G06F 16/587; H04N 1/00161

(57) ABSTRACT

A method of controlling an information processing apparatus, includes the steps of a first presentation for presenting postings on a social networking service, that have been posted by a user, a second presentation for presenting images stored in the information processing apparatus, based on a posting that the user selects from the presented postings, and analyzing an image that the user selects from the images presented in the second presentation step.

### FIELD

The present disclosure relates to an information processing apparatus, a method of controlling the information processing apparatus, and a storage medium for selecting specific image from multiple images.

### DESCRIPTION OF THE RELATED ART

There have been cases in which a user selects favorite images from a large number of images that the user took with his/her digital camera, smartphone, or the like and creates a photo album.

For example, Japanese Patent Laid-Open No. 2006-120058 discloses a technique in which images are classified into groups based on the shooting locations and displayed in the order of the shooting times in each group, by using the location information and time information recorded in the images. This makes it easy for the user to select photographs that he/she intends.

Unfortunately, even in the case of using the foregoing technique, it sometimes takes a long time to find intended images out of a large number of images. For example, in the case where the user has determined an event about which he/she wants to create a photo album, it sometimes takes a long time to find intended images in a case where the user does not remember the date and location of the event.

### SUMMARY

An object of the present disclosure is to make it easy for the user to select images that he/she intends from multiple images.

In a first aspect of the present disclosure, there is provided a method of controlling an information processing apparatus, the method comprising the steps of: a first presentation for presenting postings on a social networking service, that have been posted by a user; a second presentation for presenting images stored in the information processing apparatus, based on a posting that the user selects from the presented postings; and analyzing an image that the user selects from the images presented in the second presentation step.

In a second aspect of the present disclosure, there is provided an information processing apparatus comprising: a first presentation unit configured to present postings on a social networking service, that have been posted by a user; a second presentation unit configured to present images stored in the information processing apparatus, based on a posting that the user selects from the presented postings; and analyzing unit configured to analyze an image that the user selects from the images presented by the second presentation unit.

In a third aspect of the present disclosure, there is provided a non-transitory computer readable storage medium storing a program for causing a compute of an information processing apparatus to function as: a first presentation unit configured to present postings on a social networking service, that have been posted by a user; a second presentation unit configured to present images stored in the information processing apparatus, based on a posting that the user selects from the presented postings; and analyzing unit configured to analyze an image that the user selects from the images presented by the second presentation unit.

Further features of the present disclosure will become apparent from the following description of exemplary embodiments with reference to the attached drawings.

### BRIEF DESCRIPTION OF THE DRAWINGS

FIG. 1 is a diagram illustrating a configuration example of a system for creating/ordering photo albums in a first embodiment;

FIG. 2 is a diagram illustrating a hardware configuration example of an information processing apparatus in the first embodiment;

FIG. 3 is a flowchart of a photo-album creation process in the first embodiment;

FIG. 4 is a diagram illustrating an example of a product component selection screen in the first embodiment;

FIG. 5 is a diagram illustrating an example of a photograph selection screen in the first embodiment;

FIG. 6 is a flowchart of an event-photographs search process in the first embodiment;

FIG. 7 is a diagram illustrating an example of an SNS login screen in the first embodiment;

FIG. 8 is a sequence diagram of an SNS-information obtaining process in the first embodiment;

FIG. 9 is a diagram illustrating an example of a posting-list display screen in the first embodiment;

FIG. 10 is a flowchart of a photographs obtaining process in the first embodiment;

FIG. 11 is a flowchart of an in-terminal search process in the first embodiment;

FIG. 12 is a diagram illustrating an example of a candidate-photograph-list display screen in the first embodiment;

FIG. 13 is a diagram illustrating another example of the candidate-photograph-list display screen in the first embodiment;

FIG. 14 is a diagram illustrating an example of a posting-list display screen in a second embodiment; and

FIG. 15 is a flowchart of an in-terminal search process in the second embodiment.

### DESCRIPTION OF THE EMBODIMENTS

Hereinafter, preferred embodiments of the present disclosure will be described in detail with reference to the attached drawings. The following embodiments are not intended to limit the present disclosure according to the claims. In addition, the combination of all the features described in each embodiment below is not necessarily indispensable for the present disclosure.

In the following embodiments, description will be made, as an example, on a system that automatically lays out photographs selected by a user and creates a photo album (photo book), but the present disclosure is not limited to this example. For example, the present disclosure can also be utilized in a case where a user selects desired images from multiple images on an image editing application. Note that a photo album is also simply referred to as an album.

### First Embodiment

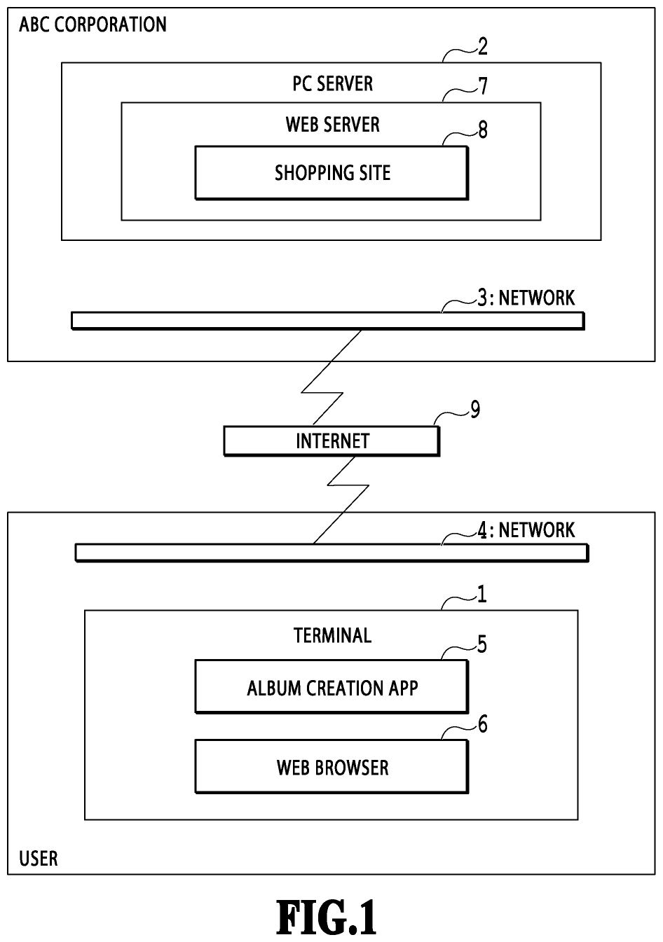

FIG. 1 is a configuration example of an information processing system in the present embodiment for creating/ordering a photo album. As shown in the illustration, the information processing system includes an information processing apparatus 1 used by a user and an information processing apparatus 2 for the company that creates photo albums. The information processing apparatus 1 may be a terminal apparatus such as a smartphone or a tablet. The information processing apparatus 1 may also be another type of apparatus, for example, a typical desktop personal computer (which may hereinafter be abbreviated as a PC), a notebook PC, an image processing apparatus such as a printer, or a KIOSK terminal. The information processing apparatus 2 may be, for example, a PC server. In the information processing apparatus 1, for example, Windows (registered trademark) 8 or the like is installed as an operating system (hereinafter referred to as an OS). In the information processing apparatus 2, for example, Windows Server 2012 or the like is installed as an OS. The information processing apparatus 1 and the information processing apparatus 2 are connected to respective networks 3 and 4 using Ethernet (registered trademark) and further communicably connected to each other via the Internet 9.

The information processing apparatus 1 has a photo-album creation application (hereinafter referred to as an album creation app) 5 installed. The album creation app 5 is constituted of, for example, an executable file (*.EXE) for Windows. The album creation app 5 functions in a case where the information processing apparatus 1 executes the executable file.

The information processing apparatus 1 also has a web browser application (hereinafter referred to as a web browser) 6 installed. The web browser 6 is used for using the World Wide Web (hereinafter, referred to as the WWW).

Note that the album creation app 5 is not limited to ones installed in advance in the information processing apparatus 1 but may be an application that is executed on the web browser 6. In this case, the program is loaded by accessing a specified website.

The network 4 is a network for the user who uses the information processing apparatus 1, which is, for example, a home network for an ordinary household.

The information processing apparatus 2 includes a web server 7 with a function of a web server and provides a website of the company (referred to as ABC corporation) via the Internet 9. The network 3 is, for example, an office network established in the company.

The shopping site 8 is a shopping site through which ABC corporation provides service for the users. The users can order photo albums using the shopping site 8.

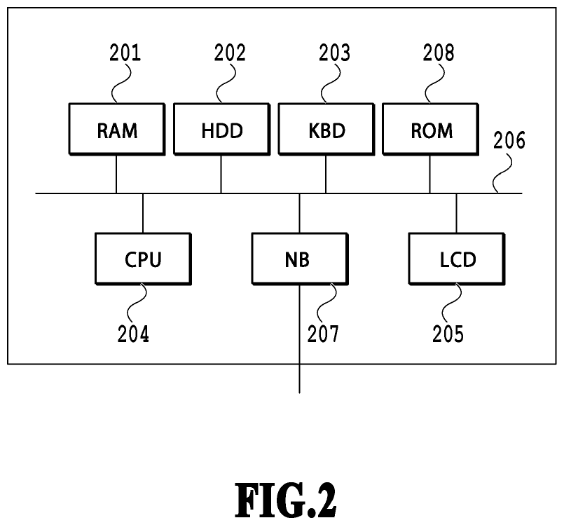

FIG. 2 illustrates a hardware configuration example of the information processing apparatus 1 and the information processing apparatus 2 in the present embodiment. As shown in the illustration, the information processing apparatus has a CPU 204, ROM 208, RAM 201, an HDD 202, a KBD 203, an LCD 205, and an NB 207, and these constituents are connected via a bus 206.

The CPU (central processing unit) 204 reads a control program stored in the ROM 208 or the HDD 202 and load into the RAM 201 to execute it. The CPU 204 is a control unit that controls the entire operation of the information processing apparatus.

The RAM 201, which is random access memory, provides a temporary storage area at the time in a case where the CPU 204 executes the control program.

The ROM 208 stores the control program executed by the CPU 204.

The HDD (hard disk drive) 202 is a storing unit that stores image data, processing results of image analysis, and the like. The HDD 202 also stores programs such as the album creation app 5 and the web browser 6.

The KBD (keyboard) 203 is an event board unit. Specifically, it is an input unit for user operations. The KBD 203 may include another input apparatus such as a mouse. Alternatively, the KBD 203 may be a touch panel integrated with the LCD 205 described later. Generally, terminal apparatuses such as smartphones and tablets include a touch panel. The users can input instructions to the information processing apparatus via various screens provided by the album creation app 5 or the web browser 6.

The LCD (liquid crystal display) 205 is a display of the information processing apparatus. Note that the display is not limited to a liquid crystal display but may be a different type of display.

The NB (network board) 207 is a communication control unit which is an apparatus for communicating with external apparatuses such as printers and servers.

Although hardware configuration example of the information processing apparatus has been described as above, the configuration is not limited to this example.

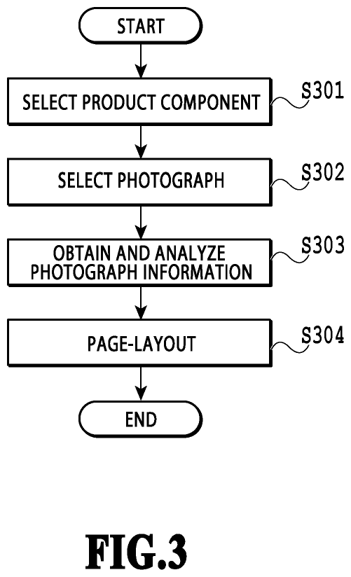

FIG. 3 is a flowchart showing a photo-album creation process in the present embodiment. A series of processes illustrated in the flowchart is performed by the CPU 204 deploying, in the RAM 201, the control program or the album creation app 5 store in the ROM 208 or the HDD 202 and executing it. Alternatively, part of the steps in the flowchart or all the functions of the flowchart may be implemented in hardware such as an ASIC or an electronic circuit. The symbol “S” at each process description means “step” in the flowchart. The same is true of the other flowcharts.

At S301, the information processing apparatus 1 displays a product component selection screen for the user to select product components for an album and obtains the product components selected by the user.

At S302, the information processing apparatus 1 displays a photograph selection screen for selecting photographs to be included in the album and obtains the image data of the photographs selected by the user. For example, in a case where the image data is stored in a certain folder in the information processing apparatus 1, the user may select the folder.

At S303, the information processing apparatus 1 obtains photograph information such as the shooting date and time and the shooting locations from the image data of the photographs selected by the user and performs analysis of the photograph information. Specifically, by the analysis, the information processing apparatus 1, for example, arranges image data pieces in time series based on the shooting date and time or divides image data pieces into groups. The information processing apparatus 1 also evaluates image data pieces and sets scores to them.

At S304, the information processing apparatus 1 performs a page-layout for the album based on the analysis results at S303 and generates album data. Specifically, in a case where images are arranged in the slots of a template, the information processing apparatus 1, for example, arranges images in the slots in time series or arranges images with higher scores in larger slots in a template. In the layout process, the information processing apparatus 1 may arrange all the images that were analyzed (the images selected by the user) or may arrange only images with higher scores.

The generated album data is displayed on the LCD 205. The album data is also transmitted to the information processing apparatus 2 via the Internet 9. The information processing apparatus 2 uses the received album data to generate print data, which can be printed with a printing apparatus to make a bound photo album using paper media.

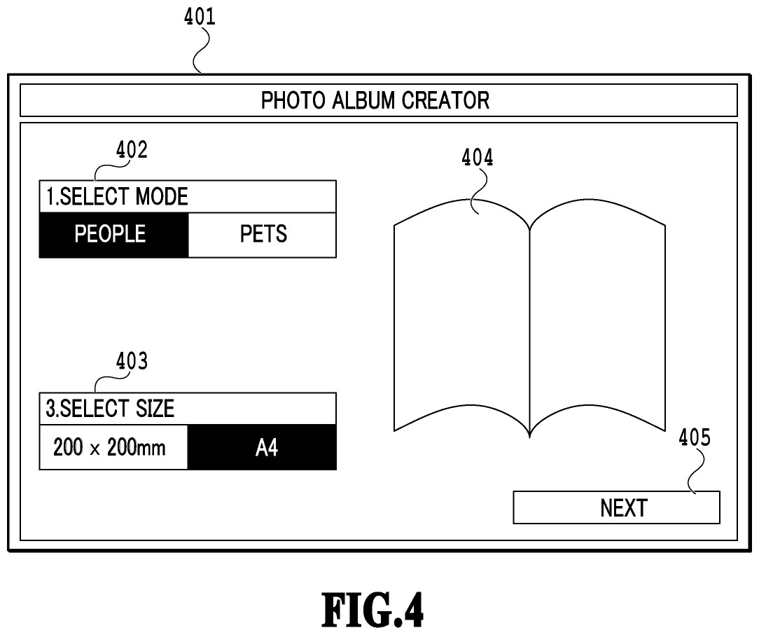

FIG. 4 illustrates an example of the product component selection screen 401 displayed at S301.

The mode selection list 402 allows the user to select one of a people mode (People) and a pet mode (Pets). In the people mode, photographs of people are preferentially selected from all the photographs selected by the user, and the selected photographs are laid out in the album. In the pet mode, photographs of pets or photographs of both pets and people are preferentially selected from all the photographs selected by the user, and the selected photographs are laid out in the album. In the example in FIG. 4, the people mode (People) is selected.

The size selection list 403 allows the user to select the size of the album. In the example of FIG. 4, from the selectable sizes of the 200×200 mm size and the A4 size, the A4 size is selected.

Based on the information selected in the mode selection list 402 and the size selection list 403, the album creation app 5 generates a sample as an album completion image 404. In the case where the user makes a reselection from the mode selection list 402 or the size selection list 403, the album creation app 5 modifies the sample of the completion image 404 accordingly. For example, in the state illustrated in FIG. 4, in the case where the user changes the selection from the A4 size to the 200×200 mm size in the size selection list 403, the completion image 404 changes into a square completion image. Because this completion image 404 is a sample, actual images that the user has are not displayed in this completion image, but sample images are displayed.

In a case where the user clicks a decision (Next) button 405, the information selected on the product component selection screen 401 is fixed.

Although in the foregoing example, product components are selected using the mode selection list 402 and the size selection list 403, the present disclosure is not limited to this example. For example, the product component selection screen 401 may have a screen on which the user can select the design of an album or specifies the number of pages.

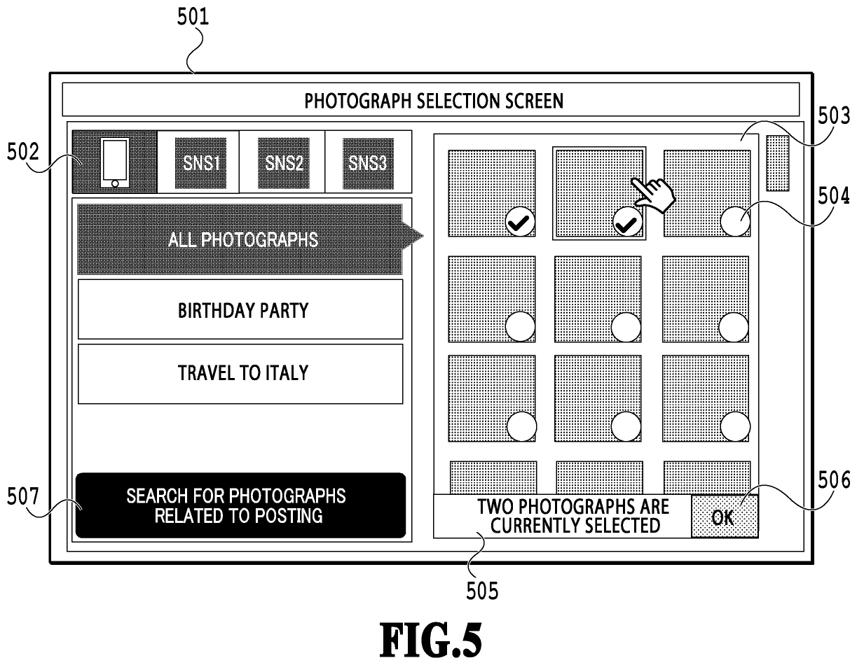

FIG. 5 illustrates an example of the photograph selection screen 501 displayed at S302. The screen transitions to the photograph selection screen 501 after the user selects the decision button 405 on the product component selection screen 401.

The user can select in the area 502 a photograph obtaining source from which photographs are to be obtained. As shown in the illustration, the user can select, for example, the terminal with which the user is operating the album creation app 5 or SNSs (social networking services) as a photograph obtaining source. In the case where the user selects the terminal, the user can further select all the photograph in the terminal or folders in the terminal. In the example of FIG. 5, two folder names, “BIRTHDAY PARTY” and “TRAVEL TO ITALY”, are displayed as selectable folders. In the example of FIG. 5, “ALL PHOTOGRAPHS” in the terminal are selected.

The area 503 displays the photographs included in the obtaining source selected in the area 502 in a thumbnail list form. In the example of FIG. 5, all the photographs in the terminal are displayed in the list form. The user can select photographs from the thumbnail list. In a case where a photograph is selected, a check mark appears in the check box 504 of the selected photograph. The check mark allows the user to confirm the selected photographs.

The area 505 displays the total number of selected photographs.

In a case where the user selects the OK button 506, the photograph selection is completed.

Thus, the user can select photographs from the terminal or SNSs as described above. However, in the case where the user has not classified photographs into folders in advance, or in the case where one folder has a large number of photographs, it takes a long time for the user to find desired photographs. Meanwhile, in the case where the user uses SNSs, there are cases in which the user takes photographs at an event and posts the taken photographs to an SNS immediately. There are also cases in which a user takes many photographs at an event and the user selects one or multiple photographs from the taken photographs after the event and posts them to an SNS. SNSs are systems (web-based service) that allow users to transmit or receive information via the Internet and share the information with other users. In general, users use SNS applications installed in their terminals or web browsers that allow the users to transmit (post) information and browse information. Transmitted information is stored in SNS servers. Users can post information on events or the like that happened around them with comments and photographs onto SNSs, using terminals that the users owns. In this way, users can transmit information to other users. That is, it is highly possible that the terminal that a user has contains photographs of the event related to the photographs that the user posted onto the SNS. Hence, in a case where photographs of the event related to posted contents which exists in the terminal are presented to the user by using comments or photographs or both that the user posted onto the SNS, the user can save time taken to find photographs of the event of interest. Thus, the user can find desired photographs easily.

The button 507 is for starting a function of searching for event photographs contained in the terminal, using contents posted onto the SNS. In a case where the user selects the button 507, the information processing apparatus 1 executes an event-photographs search process described below.

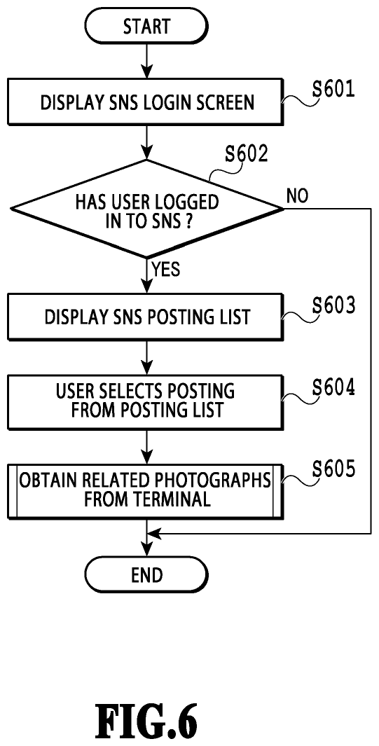

FIG. 6 illustrates a flowchart of the event-photographs search process in the present embodiment.

At S601, the information processing apparatus 1 displays a login screen (hereinafter also referred to as an authentication screen) of SNSs.

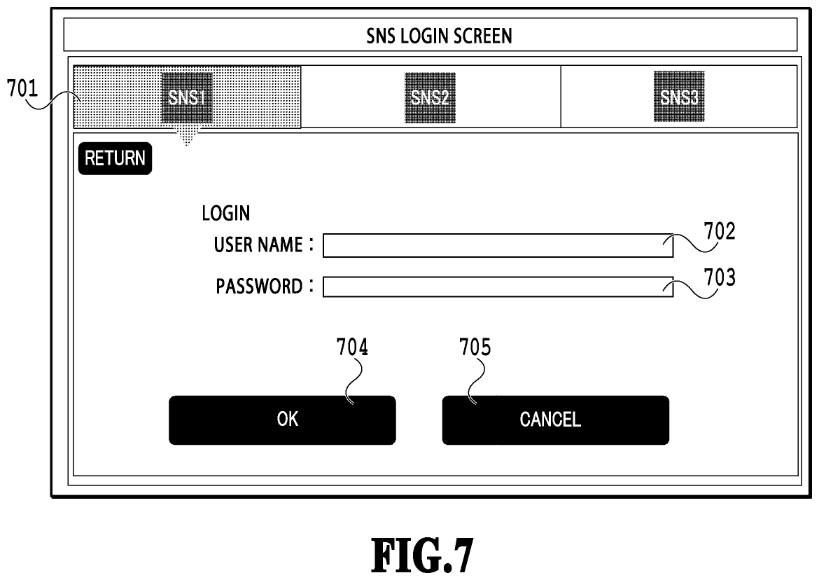

FIG. 7 illustrates an example of an SNS login screen in the present embodiment. In the area 701, the user selects an SNS from which the user is going to select postings and inputs the user name 702 and the password 703. In a case where the user selects the OK button 704, the login authentication is executed in the SNS server. Note that the user authentication method is not limited to this example, but other methods can be used.

At S602, the information processing apparatus 1 determines whether the user has logged in to an SNS. In a case where the user has logged in to an SNS, the process proceeds to S603. On the other hand, in a case where the user selects the cancel button 705 in the SNS login screen and does not log in to an SNS, the process is terminated, and the screen returns to the photograph selection screen 501 of FIG. 5.

After the user logs in to an SNS, the information processing apparatus 1 can obtain SNS information on the login user from an SNS server via an API (application programming interface) provided by the SNS.

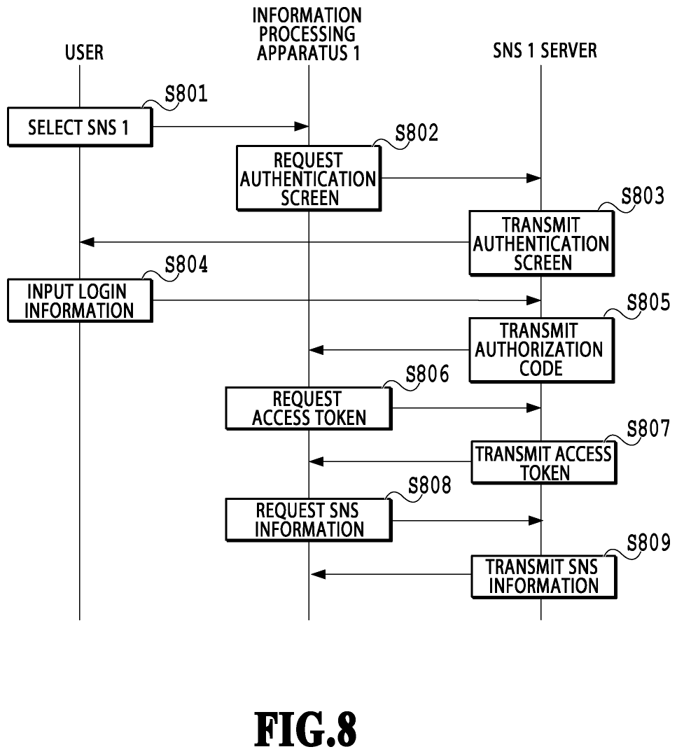

FIG. 8 is a sequence diagram of an SNS-information obtaining process in the present embodiment. The following describes procedure from when the user selects SNS 1 at S601 to when the information processing apparatus 1 obtains SNS information from SNS 1.

In a case where the user selects SNS 1 at S801, the information processing apparatus 1, at S802, requests the user authentication screen (in other words, the SNS login screen of FIG. 7) from the server apparatus (hereinafter referred to as an SNS 1 server) that provides SNS 1.

At S803, the SNS 1 server transmits the authentication screen to the information processing apparatus 1, and at S804, the user inputs login information into the authentication screen displayed on the information processing apparatus 1. At S805, the SNS 1 server verifies the login information, and in a case where it is correct, the SNS 1 server transmits an authorization code to the information processing apparatus 1.

At S806, the information processing apparatus 1, which has received the authorization code, requests from the SNS 1 server an access token for obtaining information on the user. This is because without the access token, the information processing apparatus 1 cannot obtain SNS information on the user from SNS 1.

At S807, the SNS 1 server transmits an access token to the information processing apparatus 1. At S808, the information processing apparatus 1, which has received the access token, sends a request for SNS information on the user with the access token to the SNS 1 server. At S809, the SNS 1 server transmits the SNS information on the user requested by the information processing apparatus 1 to the information processing apparatus 1.

As described above, once the user's login succeeds, the information processing apparatus 1 can obtain SNS information on the user. The obtained SNS information includes posted information such as comment information posted by the user, posting date information, posting location information, photographs posted at the same time (posted images), and folder information (a folder name sometimes indicates the title of an album). In addition, the obtained SNS information may include user information, information on comments that the user exchanged with other followers through the SNS, and the like. Note that the SNS information is not limited to these examples but may include other information.

Returning to FIG. 6, at S603, the information processing apparatus 1 displays posted information including photographs in a list form, using the SNS information obtained by logging in. In other words, the information processing apparatus 1 presents postings on the SNS to the user. Specifically, the information processing apparatus 1 displays posted contents on the display of the information processing apparatus 1.

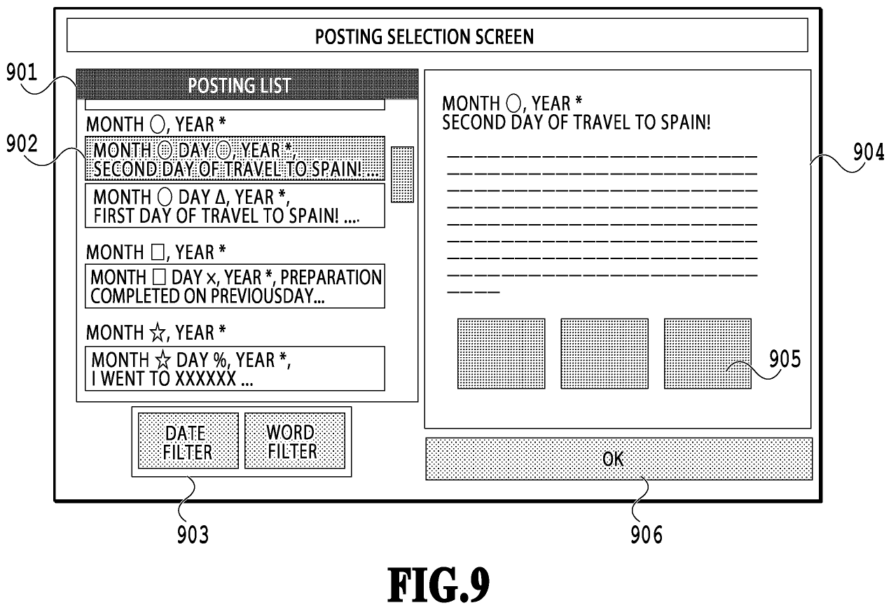

FIG. 9 illustrates an example of a posting-list display screen in the present embodiment. The area 901 displays postings including photographs in a list form. In the case where the SNS is of a type in which users post information in units of events, postings may be displayed classified in units of months as illustrated in the area 901. In the case where the SNS is a type in which users tweet about their daily lives, postings may be displayed classified in units of dates.

The posting 902 includes the posting date and the comment. A posting may include only comments and may also include information on comments from other users.

The area 903 shows filtering functions such as a date filter and a word filter. The filtering functions make it easy for the user to find desired postings in the case where the number of postings is large or other cases. The date filter, in a case where the user specifies a date or a certain period, extracts corresponding postings. The word filter, in a case where the user specifies a keyword, extracts related postings.

The area 904 shows concrete contents of the posting selected in the area 901 by the user. In the illustrated example, the area 904 shows the posting date, posted text, and posted photographs 905 in a thumbnail form.

The OK button 906 is for determining a posting. In a case where the user selects a posting related to the event that the user wants to include in the album and selects the OK button 906, S604 ends.

At S605, the information processing apparatus 1 obtains related photographs out of the photographs in the terminal, based on the contents of the posting selected by the user. The related photographs mean photographs taken in the same event as the posted contents are concerned. The related photographs can be obtained by extracting photographs having the same time information (for example, the same date) and the same location information as the posted contents, out of the photographs in the terminal. The time information can be a specified period based on the posting date instead of the same date. The location information can be within a specified range based on the posting location.

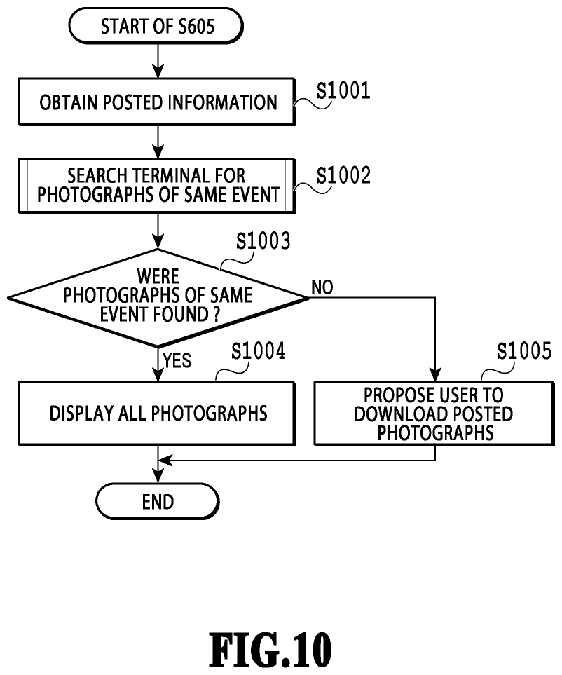

FIG. 10 is a flowchart showing a photographs obtaining process in the present embodiment.

At S1001, the information processing apparatus 1 recognizes the posting selected by the user and obtains posted information on the posting. The posted information includes comment information, posting date information, posting location information, and posted photographs (in other words, posted images).

At S1002, the information processing apparatus 1 searches for photographs of the same event which are contained in the terminal based on the obtained posted information.

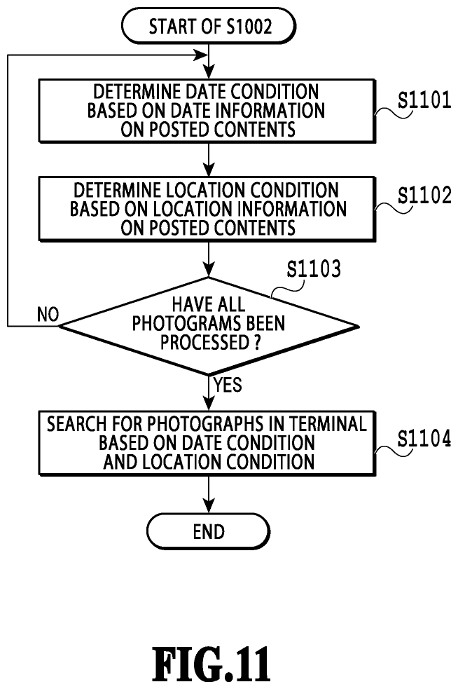

FIG. 11 illustrates a flowchart of an in-terminal search process in the present embodiment.

At S1101, the information processing apparatus 1 obtains posting date information included in the posted information and determines a date condition for searching for photographs of the same event. Posting date information may be obtained from Exif information of posted photographs or may be obtained from posted comments. Alternatively, the posting date obtained from the SNS information can be used as posting date information. Note that since there are cases where there is a certain period between the date of an event and the date in a case where information on the event is posted onto an SNS, the date of posting onto an SNS does not always agree with the date in a case where the event was held. Hence, it is preferable to set a specified period before the posting date as a date condition. For example, assuming that the posting date is November 3, a period from the day 7 days before the posting date to the posting date is set as the date condition.

At S1102, the information processing apparatus 1 obtains posting location information included in the posted information and determines a location condition for searching for photographs of the same event. The posting location information is information on the location where the event was held. Posting location information can be obtained from Exif information of posted photographs, or the location information obtained from the SNS information can be used as the posting location information.

For the above S1101 and S1102, it is desirable to use preferentially the Exif information of posted photographs to determine the date condition and the location condition. This is because Exif information is automatically attached to a photograph by the image capturing apparatus in a case where the photograph is taken and cannot be modified easily by the user, and hence it is highly likely that Exif information is correct information. On the other hand, it is possible that the date and location information of comment information or the like on an SNS is not correct information. Note that depending on the type of SNS, Exif information is deleted, in some cases, from posted photographs on the purpose of the protection of privacy or the like. In such a case, it is impossible to obtain date information and location information from posted photographs, and thus, date information and location information need to be obtained from comment information or the like on the SNS.

For example, in the case where the user selects a posting on a travel (event) for two days of November 3 and 4, the two days of November 3 and 4 are obtained as the posting date information, and this period can be set as the date condition. In the case where a posting selected by the user includes posting date information of multiple dates, the period including the dates can be set as the date condition, or each separate date can be set as the date condition.

At S1103, the information processing apparatus 1 determines whether all the posted photographs have been processed. In a case where unprocessed posted photographs remain, S1101 and S1102 are executed repeatedly. In the case where the user selected multiple postings, the date condition and the location condition can be multiple. For example, in the case where the user selected postings on events held on November 3 and December 4, the two dates of November 3 and December 4 can be the date condition. In a case where all the posted photographs have been processed, the process proceeds to S1104.

At S1104, the information processing apparatus 1 searches for photographs in the terminal based on the determined date condition and location condition. Here, the information processing apparatus 1 obtains date information and location information from the Exif information of the photographs in the terminal and obtains photographs that corresponds to the date condition and location condition. In other words, the information processing apparatus 1 obtains photographs of the same event as the event that the posting selected by the user is concerned with.

Returning to FIG. 10, at S1003, the information processing apparatus 1 determines whether photographs of the same event as the event that the posting selected by the user is concerned with were found in the terminal. If photographs were found, the process proceeds to S1004, and if not, the process proceeds to S1005.

At S1004, the information processing apparatus 1 displays all the photographs that are of the same event as the event that the posting selected by the user is concerned with, and are found in the terminal. In other words, the information processing apparatus 1 presents all the photographs of the same event found in the terminal to the user as candidate photographs. In the following, these photographs found in the terminal are also referred to as candidate photographs which may be selected as a photograph to be used for the album.

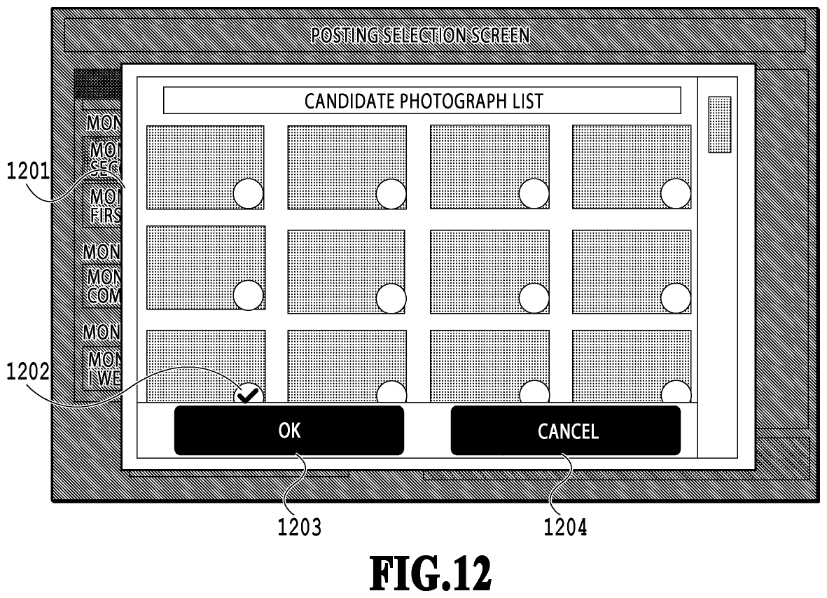

FIG. 12 illustrates an example of a candidate-photograph-list display screen in the present embodiment. The candidate-photograph-list display screen allows the user to select photographs to be used for the album.

The area 1201 displays candidate photographs in a list form. In a case where the user selects a photograph, a check mark appears in the check box 1202. In a case where the user selects the OK button 1203, photograph selection from the candidate photographs is completed. On the other hand, the user can cancel the photograph selection by selecting the cancel button 1204.

At S1005, the information processing apparatus 1 displays the posted photographs that are included in the posting and are selected by the user in a list form and proposes downloading those photographs to the user.

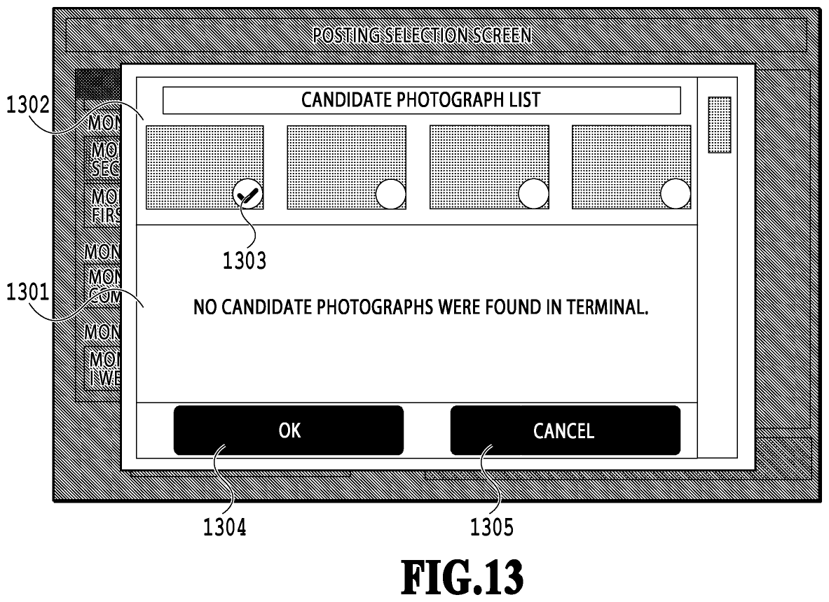

FIG. 13 illustrates another example of a candidate-photograph-list display screen in the present embodiment. Specifically, the candidate-photograph-list display screen of FIG. 13 is an example of a screen that is displayed in the case where candidate photographs were not found.

The area 1301 displays a message indicating that no candidate photographs were found in the terminal. In the example of FIG. 13, a message “NO CANDIDATE PHOTOGRAPHS WERE FOUND IN TERMINAL” is displayed.

The area 1302 displays the photographs included in the posting selected by the user in a list form. In a case where the user selects a photograph, a check mark appears in the check box 1303. In a case where the user selects the OK button 1304, the information processing apparatus 1 downloads selected photographs from the SNS. In other words, the information processing apparatus 1 downloads selected images from the SNS server. With this operation, photographs of a desired event on which photographs were not found in the terminal can be used for the album. On the other hand, in a case where the user selects the cancel button 1305, the downloading is cancelled.

The processes described above with reference to FIGS. 6 to 13 are performed in a case where the user executes the function of searching for photographs from postings, in the photograph selection screen 501 of FIG. 5. Through these processes, the user, at S302 in FIG. 3, can select photographs to be analyzed and included in the album, from photographs (candidate images) related to postings on SNSs.

As has been described above, the present embodiment makes it easy for the user to select intended images from multiple images by utilizing postings on SNSs.

### Second Embodiment

In the first embodiment, based on comments and photographs posted on SNSs by the user, a desired posting is selected, and photographs are searched for in the terminal. However, some SNSs share only photographs. In the present embodiment, description will be made of a method of selecting a posting on an SNS and procedure for searching for photographs in the terminal using the posting in such a case, specifically, in the case where the SNS is of a type on which only photographs are posted and shared. In the following description, description of parts common to those in the first embodiment is omitted, and parts different from those in the first embodiment are mainly described.

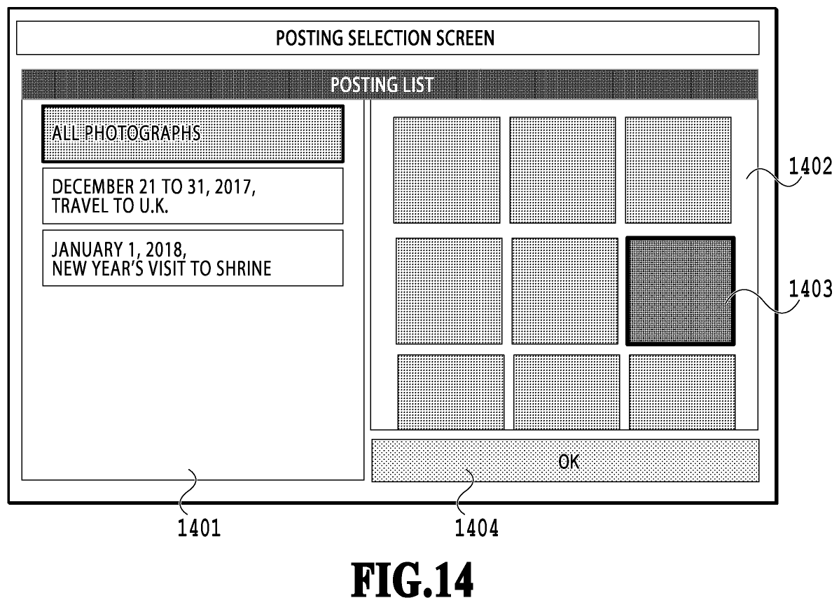

FIG. 14 illustrates an example of a posting-list display screen in the present embodiment.

The area 1401, in the case where the SNS has folders, displays the folder list.

The area 1402 displays posted photograph included in the folder selected by the user in the area 1401 in a thumbnail list form. In the example of FIG. 14, “ALL PHOTOGRAPHS” are displayed in a thumbnail list form. The area 1402 may display not only the thumbnails but also, for example, the dates on which the photographs were posted.

The user can select one or more photographs that the user has posted on the SNS from the thumbnail list displayed in the area 1402. In the example of FIG. 14, the thumbnail 1403 of a posted photograph currently selected is highlighted to make it easy for the user to recognize the posted photograph that the user is selecting.

In a case where the user selects the OK button 1404, the selection of posted photographs is completed.

Next, the information processing apparatus 1 starts an in-terminal search process in the present embodiment.

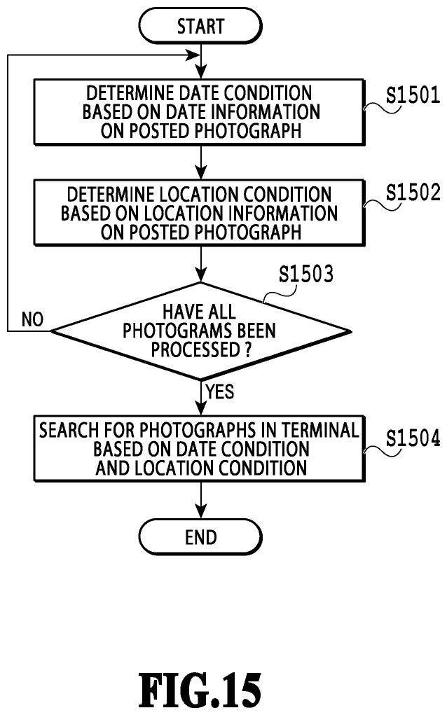

FIG. 15 illustrates a flowchart of the in-terminal search process in the present embodiment.

At S1501, the information processing apparatus 1 obtains date information on the posted photographs selected by the user and determines a date condition for searching for photographs of the same event. Date information on a posted photograph means, for example, shooting date information that can be obtained from Exif information of the posted photograph. In the case where a posted photograph does not have Exif information, the posting date obtained from the SNS information may be used as the date information. Note that since there are cases where there is a certain period between the date of an event and the date in a case where information on the event is posted onto an SNS, the date of posting onto an SNS does not always coincide with the date in a case where the event was held. Hence, it is preferable to set a specified period before the posting date as the date condition. For example, in the case where a date condition is to be determined from a posting dated Jan. 1, 2018, the date condition may be set to a period from the day 10 days before the posting date to the posting date, which means “Dec. 21, 2017 to Jan. 1, 2018”.

In the case where date information can be obtained from the name of the folder containing the posted photographs in the SNS, the date information included in the folder name can be used. For example, in the case where the images in the folder “DECEMBER 21 TO 31, 2017, TRAVEL TO U.K.” included in the area 1401 in FIG. 14 are selected, the information processing apparatus 1 obtains the period “December 21 to 31, 2017” as the date information.

At S1502, the information processing apparatus 1 obtains the location information on the posted photographs that the user selected and determines a location condition for searching for photographs of the same event. The location information on posted photographs means, for example, the shooting location information that can be obtained from Exif information of the posted photographs. In the case where a posted photograph does not have Exif information, location information can be obtained from the name of the folder containing the posted photographs in the SNS. For example, in the case where the images in the folder “DECEMBER 21 TO 31, 2017, TRAVEL TO U.K.” included in the area 1401 in FIG. 14 are selected, the information processing apparatus 1 obtains “U.K.” as the location information.

At S1503, the information processing apparatus 1 determines whether all the posted photographs have been processed. If all the posted photographs have been processed, the process proceeds to S1504, and if not, S1501 and S1502 are executed repeatedly.

At S1504, the information processing apparatus 1 searches for photographs in the terminal based on the determined date condition and location condition and obtains photographs that correspond to the date condition and location condition.

As has been described above, the present embodiment makes it easy for the user to select intended images from multiple images even in the case of using SNSs that share only images.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure makes it easy for the user to select intended images from multiple images.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-128269, filed Jul. 10, 2019, which is hereby incorporated by reference wherein in its entirety.

What is claimed is:

1. A method of controlling an information processing apparatus, the method comprising the steps of:
a first presentation for presenting postings on a social networking service, that have been posted by a user;
a second presentation for presenting images stored in the information processing apparatus, based on a posting that the user selects from the presented postings; and
analyzing an image that the user selects from the images presented in the second presentation step.

2. The method according to claim 1 wherein the first presentation step causes a display to display any of comments and photographs or both of the comments and photographs, that have been posted on the social networking service by the user.

3. The method according to claim 1 further comprising the step of obtaining date information and location information from posted information on the posting that the user selects, and
wherein the second presentation step causes a display to display the images stored in the information processing apparatus, based on the obtained date and location information.

4. The method according to claim 3 wherein the posted information includes a posted image, and
the obtaining step obtains the date information and the location information from the posted image.

5. The method according to claim 4 wherein the posted image includes Exif information.

6. The method according to claim 3 wherein the posted information includes a comment by the user, and
the obtaining step obtains the date information and the location information from the comments.

7. The method according to claim 3 wherein the second presentation step presents the images taken in a specified period based on the date information obtained from the posted information.

8. The method according to claim 1 wherein the second presentation step presents the images stored in the information processing apparatus, based on the multiple postings that the user selects.

9. The method according to claim 1 wherein the second presentation step presents images posted on the social networking service, in the case where images related to the posting that the user selects is not found in the information processing apparatus, and
the method further comprising the step of downloading the posted images that the user selects, from the social networking service.

10. The method according to claim 1 further comprising the step of generating album data which lays out images, based on an analysis result of the analyzing step.

11. An information processing apparatus comprising:
a first presentation unit configured to present postings on a social networking service, that have been posted by a user;
a second presentation unit configured to present images stored in the information processing apparatus, based on a posting that the user selects from the presented postings; and
analyzing unit configured to analyze an image that the user selects from the images presented by the second presentation unit.

12. A non-transitory computer readable storage medium storing a program for causing a compute of an information processing apparatus to function as:
a first presentation unit configured to present postings on a social networking service, that have been posted by a user;
a second presentation unit configured to present images stored in the information processing apparatus, based on a posting that the user selects from the presented postings; and
analyzing unit configured to analyze an image that the user selects from the images presented by the second presentation unit.
